(19) United States
(12) Patent Application Publication
(10) Pub. No.: US 2010/0205074 A1
(43) Pub. Date: Aug. 12, 2010

(54) Network leasing system and method thereof

(75) Inventors: Chaucer Chiu, Taipei (TW); Hui Wang, Shanghia (CN); Tao Zhou, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/320,847

(22) Filed: Feb. 6, 2009

(51) Int. Cl. G06Q 10/00; G06Q 20/00

(52) U.S. Cl. 705/30

(57) ABSTRACT

A network leasing system and a method thereof are provided, which lease a translation service through network connection, generate an authentication code based on a product serial number, and use the authentication code to decide whether to install a program data or not, so as to solve the problems that a software lease service cannot be performed in a network and an installation of an illegal program data cannot be restricted, thereby implementing a software lease service in a network, and achieving the technical effect of providing a translation service to a lessee in real time by an authentication process.

### BACKGROUND OF THE INVENTION

1. Field of the Invention

The present invention relates to a network leasing system and a method thereof, and more particularly to a network leasing system for a translation service and a method thereof.

2. Related Art

With the rapid progress of information technology and the popularity of internet, under the prevailing trend of the information global village, the information sources for modern people are no longer limited to one's own country. Information all over the world becomes available easily, and swarms into the modern people's life through various routes such as TV, books and magazines, as well as networks. Accordingly, the opportunities for contacting foreign languages are greatly increased. Thus, it has become one of the necessary means for the modern people to contact and learn a second or even a third foreign language, so as to cater to the prevailing trend.

In learning a foreign language, the modern people tend to use a dictionary to look up a word, and translation software derived from traditional paper dictionaries speeds up the process for looking up words. For general translation software, it is installed in a user's personal computer or notebook after the user has purchased an install disc for the translation software. With the increasing of the functions for the translation software, some functions provided in the install disc that are not required by the user are also purchased and installed. As for the user, many unnecessary translation functions are purchased; and it adds an additional load for the execution performance of a computer. Furthermore, with the rapid development of Internet, more and more people like to do shopping over network. Therefore, how to combine the translation software with the network and how to avoid piracy of the translation software have become important issues worth considering.

To sum up, there have been problems in the prior art for a long time that the software lease service cannot be performed in a network and the illegal program data installation cannot be restricted. Therefore, it is necessity to propose an improved technical solution to solve the above problems.

### SUMMARY OF THE INVENTION

In view of the problems in the prior art that the software lease service cannot be performed in a network and the illegal program data installation cannot be restricted, the present invention is directed to a network leasing system and a method thereof.

The network leasing system provided in the present invention at least includes a translation service receiving end and a translation service providing end. The translation service receiving end is adapted to send a product serial number. The translation service providing end is adapted to set up a network connection with the translation service receiving end. The translation service providing end includes a providing module, a charging module, a transaction module, a computing module, and a transferring module. The providing module is adapted to provide at least one function option and a day number setting to the translation service receiving end based on the product serial number. The charging module is adapted to calculate the expenses based on the function options and the day number setting selected by the translation service receiving end, and generate a payment means. The transaction module is adapted to provide the payment means for the translation service receiving end to implement a payment transaction. The computing module is adapted to generate an authentication code based on the product serial number. The transferring module is adapted to transfer the authentication code and at least one program data corresponding to the selected function options to the translation service receiving end through the network connection. The translation service receiving end authenticates that whether the authentication code is correct or not, and if yes, the translation service receiving end installs the program data, otherwise, it refuses to install the program data.

The network leasing method provided in the present invention at least includes the following steps. A network connection is set up between a translation service receiving end and a translation service providing end. The translation service receiving end sends a product serial number to the translation service providing end. The translation service providing end provides at least one function option and a day number setting to the translation service receiving end based on the product serial number. The translation service providing end calculates the expenses based on the function options and the day number setting selected by the translation service receiving end, and generates a payment means. The translation service providing end provides the payment means for the translation service receiving end to implement a payment transaction. The translation service providing end generates an authentication code based on the product serial number, and transfers the authentication code and at least one program data corresponding to the selected function options to the translation service receiving end. The translation service receiving end authenticates whether the authentication code is correct or not, and if yes, the translation service receiving end installs the program data, otherwise, it refuses to install the program data.

The system and method of the present invention have been described above, and the difference with the prior art lies in that, the present invention performs the translation service lease through network connection, generates an authentication code based on a product serial number, and uses the authentication code to decide whether to install a program data or not.

Through the above technical means, the present invention can achieve the technical effect of providing the translation service to a lessee in real time by an authentication process when a software lease service is implemented in a network.

### BRIEF DESCRIPTION OF THE DRAWINGS

The present invention will become more fully understood from the detailed description given herein below for illustration only, which thus is not limitative of the present invention, and wherein:

FIG. 1 is a block diagram of a network leasing system according to the present invention.

FIG. 2 is a block diagram of a network leasing system according to the present invention.

FIG. 3 is a flow chart of a network leasing method according to the present invention.

FIGS. 4-6 are schematic views of a network leasing system according to embodiments of the present invention.

### DETAILED DESCRIPTION OF THE INVENTION

The detailed features and advantages of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification, claims, and drawings.

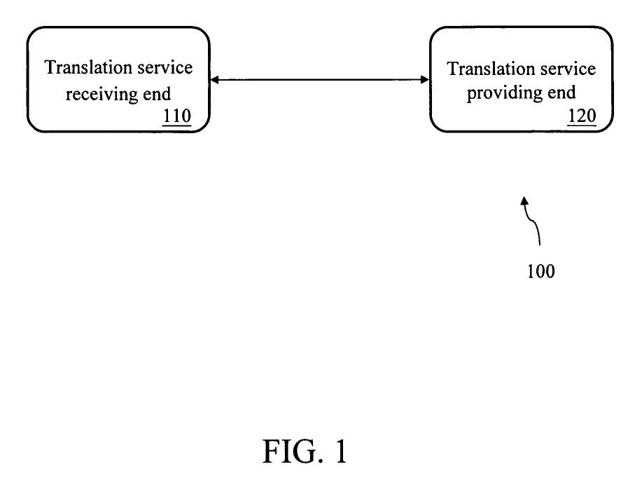

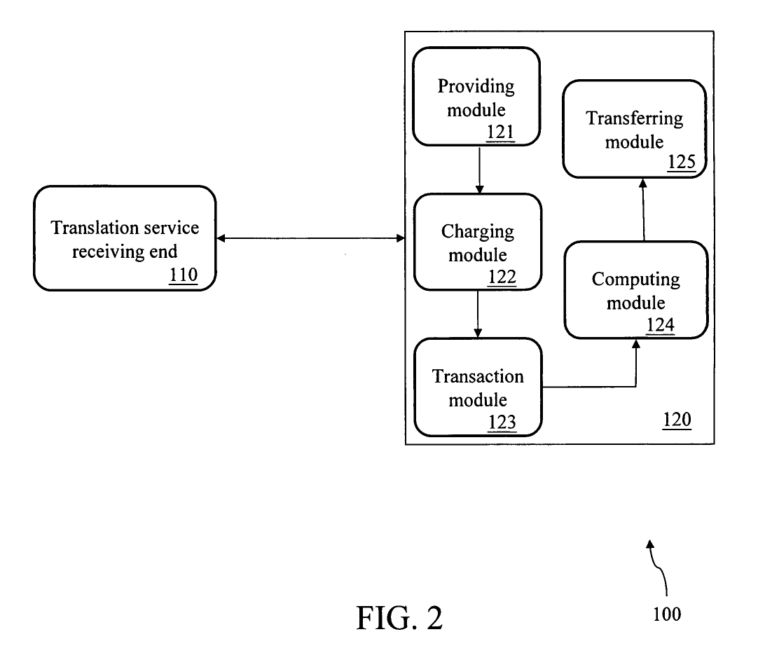

Before illustrating the embodiments of the present invention, a lease service system for translation and lookup and a method thereof in the present invention are further illustrated with reference to the drawings. FIGS. 1 and 2 are block diagrams of a network leasing system according to the present invention. Referring to FIGS. 1 and 2, a network leasing system 100 includes a translation service receiving end 110 and a translation service providing end 120. The translation service providing end 120 includes a providing module 121, a charging module 122, a transaction module 123, a computing module 124, and a transferring module 125.

Referring to FIG. 1, the translation service receiving end 110 is used for sending a product serial number. It should be noted that, the translation service receiving end 110 is translation software installed on a personal computer or a notebook, i.e., translation software that can be used for translation and lookup on a personal computer or a notebook. The product serial number is a serial number of a software product at the translation service receiving end 110.

The translation service providing end 120 sets up a network connection with the translation service receiving end 110. It should be noted that, the translation service providing end 120 is a server for providing a translation service. Therefore, the translation service receiving end 110 sends the product serial number to the translation service providing end 120 through network connection.

Referring to FIG. 2, the translation service providing end 120 includes a providing module 121, a charging module 122, a transaction module 123, a computing module 124, and a transferring module 125. When the translation service receiving end 110 sends a product serial number to the translation service providing end, the providing module 121 is used for providing function options and a day number setting based on the product serial number to the translation service receiving end 110, in which the function options are the function options that the translation service receiving end 110 does not install yet. For example, the function options may include English-Chinese and Chinese-English dictionary functions, Japanese-Chinese and Chinese-Japanese dictionary functions, a human voice pronunciation function, and so on. The day number setting refers to a valid period during which the function options can be used. For example, the day number setting may be 10 days, 30 days, 180 days, and so on, which is automatically set by the translation service receiving end 110. In other words, when translation software, i.e., the translation service receiving end 110, is installed on a personal computer or a notebook for the first time, the function options that the translation service receiving end 110 has installed are recorded based on the product serial number. Therefore, the providing module 121 of the translation service providing end 120 can get to know the function options that the translation service receiving end 110 does not install yet based on the product serial number of the translation service receiving end 110, and provide the uninstalled function options and corresponding valid periods of the function options for being selected by the translation service receiving end 110.

The charging module 122 is used for computing the expenses based on the function options and the day number setting selected by the translation service receiving end 110, and generating a payment means. It should be noted that, the payment means refers a payment manner, which may be any payment manner selected from cash, credit card, or IC card. That is, after the translation service receiving end 110 selects the function option to be installed additionally and sets the valid day number for the function option, the charging module 122 calculates the expenses based on the selection made by the translation service receiving end 110, and generates a payment means for the translation service receiving end 110 to make a payment.

The transaction module 123 is used for providing the payment means for the translation service receiving end 110 to implement a payment transaction. That is to say, the translation service receiving end 110 can make the payment through network payment manners, for example, network account transfer, or network credit card payment, thereby implementing the payment transaction. Taking the network credit card payment as an example, the translation service receiving end 110 may finish the payment by using an on-line credit card transaction through network connection based on the payment means provided by the transaction module 123.

The computing module 124 is used for generating an authentication code based on the product serial number after the translation service receiving end 110 has finished the payment transaction. That is, the calculating module 124 generates the authentication code based on the product serial number through an authentication program. Since it belongs to the prior art to generate the authentication code based on the product serial number through an authentication program, it is not described in detail here.

The transferring module 125 is used for transferring the authentication code generated by the computing module 124 and a program data corresponding to the selected function options to the translation service receiving end 110 through network connection. The program data refers to the program data required for installing the additional function options selected by the translation service receiving end 110. In other words, the transferring module 125 transfers the authentication code generated by the computing module 124 and the program data required for installing the function option to the translation service receiving end 110 through network connection.

It should be noted that, as for the valid day number of the program data for the selected function options, the valid period of the program data is set based on the day number setting set by the translation service receiving end 110. For example, if the time for beginning to use the program data of the selected function option is “11:00, Sep. 10, 2008”, and the day number setting is 30 days, the program data is valid until “11:00, Oct. 10, 2008”.

After receiving the authentication code and the program data corresponding to the selected function option, the translation service receiving end 110 starts to install the program data. It should be noted that, both the translation service receiving end 110 and the translation service providing end 120 have an authentication program, so that the translation service providing end 120 generates the authentication code based on the product serial number through the authentication program, whereas the translation service receiving end 110 authenticates the authentication code through the authentication program. That is to say, the translation service receiving end 110 generates an authentication code through the authentication program based on the product serial number and compares the generated authentication code with that generated by the translation service providing end 120 to see whether they are the same or not. Alternatively, the translation service receiving end 110 calculates a product serial number based on the authentication code through a reverse computation of the authentication program, and compares to see whether the calculated product serial number is the same with the original product serial number provided by the translation service receiving end 110. Therefore, the translation service receiving end 110 authenticates whether the authentication code is correct or not, and if yes, the translation service receiving end 110 installs the program data, otherwise, it refuses to install the program data. For example, when the translation service receiving end 110 starts to install the program data, the translation service receiving end 110 calculates to generate an authentication code based on its own product serial number through the authentication program provided by the translation service providing end 120, and then authenticates whether the authentication code generated by the translation service receiving end 110 is the same as that transferred by the translation service providing end 120 or not, or the translation service receiving end 110 obtains a product serial number based on the authentication code through a reverse computation of the authentication program to authenticate whether the authentication code is correct or not, and if yes, the translation service receiving end 110 installs the program data, otherwise, it refuses to install the program data.

In the operation of the above network leasing system, through performing a translation service lease via network connection, generating an authentication code based on a product serial number, and using the authentication code to decide whether to install the program data or not, the system of the present invention solves problems that a software lease service cannot be performed in a network and illegal program data installation cannot be restricted.

The present invention is further illustrated in detail below through embodiments with reference to a flow chart of a method of the present invention, which are not intended to limit the present invention. The following embodiments can be modified slightly by persons skilled in the art according to the spirit of the present invention, which falls within the scope of the present invention.

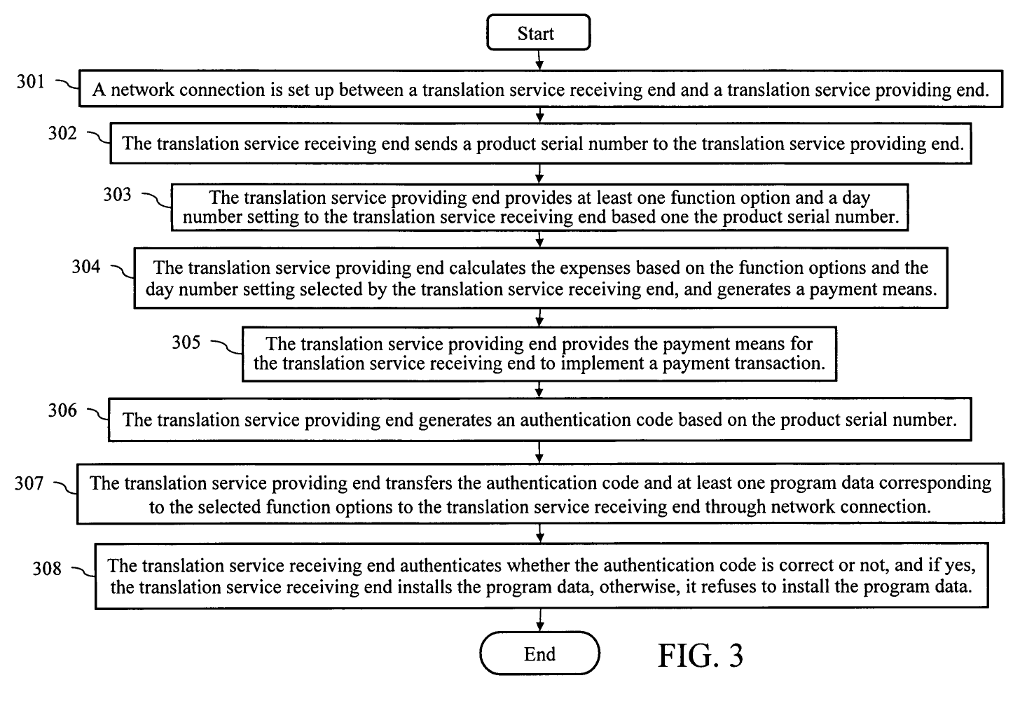

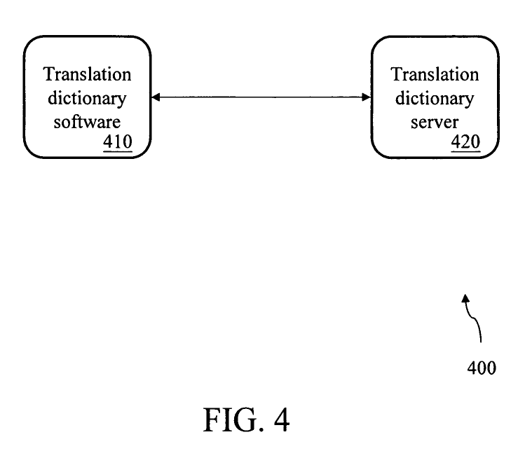

FIG. 3 is a flow chart of a network leasing method according to the present invention, and FIGS. 4-6 are schematic views of a network leasing system according to embodiments of the present invention. Referring to FIGS. 3-6, the operation steps and embodiments of the network leasing system of the present invention are illustrated below.

Referring to FIG. 4 first, a network leasing system 400 includes a translation dictionary software 410 (i.e., translation service receiving end) and a translation dictionary server 420 (i.e., translation service providing end). A network connection is set up between the translation dictionary software 410 and the translation dictionary server 420 (Step 301). The translation dictionary software 410 is a software installed on a personal computer. The translation dictionary server 420 is a server for providing a translation dictionary lease service. After the network connection is set up between the translation dictionary software 410 and the translation dictionary server 420, the translation dictionary software 410 sends a product serial number (for example, “ABC123456”) of the translation dictionary software 410 to the translation dictionary server 420 through network connection (Step 302).

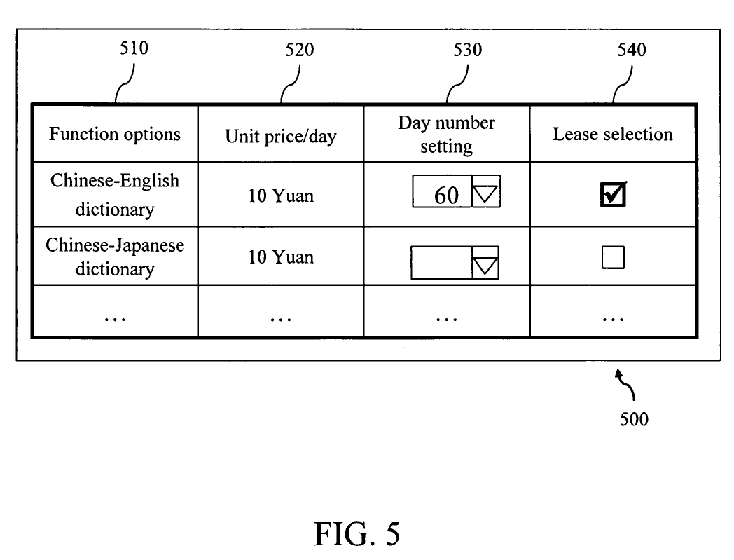

Referring to FIG. 5, a translation dictionary lease selection interface 500 includes function options 510, a unit price/day 520, a day number setting 530, and a lease selection 540. After receiving the product serial number “ABC123456” of the translation dictionary software 410, the translation dictionary server 420 gets to know the functions that the translation dictionary software 410 has already installed based on the product serial number “ABC123456”, and displays the function options 510 (for example, “Chinese-English dictionary”, “Chinese-Japanese dictionary”, and so on) that the translation dictionary software 410 does not install yet and the unit price/day 520 (for example, “10 Yuan”) for each function option 510 on the translation dictionary lease selection interface 500, and provides the day number setting for the translation dictionary software 410 to perform the lease selection of the function options (Step 303).

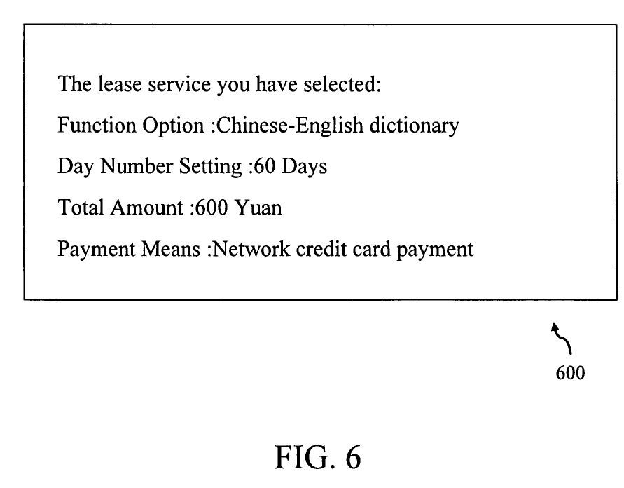

Referring to FIG. 6, when the translation dictionary software 410 selects to lease the function option 510 “Chinese-English dictionary”, and selects the day number setting 530 of “60 days”, a translation dictionary payment interface 600 displays that the translation dictionary software 410 selects to lease Chinese-English dictionary for 60 days. The translation dictionary server 420 calculates the expenses to be 600 Yuan based on the function options 510 “Chinese-English dictionary” of the translation dictionary software 410 and the day number setting 530 of “60 days”, and generates a payment means of network credit card payment (Step 304). Then, the translation dictionary server 420 provides the payment means of network credit card payment for the translation dictionary software 410 to implement a payment transaction (Step 305).

After the translation dictionary software 410 has finished the payment transaction, the translation dictionary server 420 calculates to generate an authentication code, for example, “ABC21” based on the product serial number, for example, “ABC123456”, through an authentication program, for example, “ABC(1+2+3+4+5+6)” (Step 306). Then, the translation dictionary server 420 transfers the authentication code “ABC21” and a program data corresponding to the function option 510 “Chinese-English dictionary” to the translation dictionary software 410 through network connection (Step 307).

After receiving the authentication code “ABC21” and the program data corresponding to the function option 510 “Chinese-English dictionary” transferred by the translation dictionary server 420, the translation dictionary software 410 starts to install the program data. Meanwhile, the translation dictionary software 410 authenticates whether the authentication code “ABC21” is correct or not in the following manner. The translation dictionary software 410 obtains a product serial number “ABC123456” through a reverse computation of the authentication program “ABC(1+2+3+4+5+6)”, and then compares the obtained product serial number with the original product serial number “ABC123456” of the translation dictionary software 410 to see whether they are the same or not, and if yes, it is determined that the authentication code is correct, and thus the program data can be installed (Step 308).

To sum up, the difference between the present invention and the prior art lies in that, the present invention performs a translation service lease through network connection, generates an authentication code based on a product serial number, and uses the authentication code to decide whether to install a program data or not, thereby solving the problems in the prior art that a software lease service cannot be performed in a network and illegal program data installation cannot be restricted, and achieving the technical effect of providing a translation service to a lessee in real time by an authentication process when a software lease service is implemented in the network.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A network leasing system, at least comprising:
a translation service receiving end, adapted to send a product serial number; and
a translation service providing end, adapted to set up a network connection with the translation service receiving end, wherein the translation service providing end comprises:
a providing module, adapted to provide at least one function option and a day number setting to the translation service receiving end based on the product serial number;
a charging module, adapted to calculate expenses based on the function options and the day number setting selected by the translation service receiving end, and generate a payment means;
a transaction module, adapted to provide the payment means for the translation service receiving end to implement a payment transaction;
a computing module, adapted to generate an authentication code based on the product serial number; and
a transferring module, adapted to transfer the authentication code and at least one program data corresponding to the selected function options to the translation service receiving end through network connection;
wherein the translation service receiving end authenticates whether the authentication code is correct or not, and if yes, the translation service receiving end installs the program data, otherwise, the translation service receiving end refuses to install the program data.

2. The network leasing system according to claim 1, wherein the translation service receiving end is installed in a personal computer or a notebook.

3. The network leasing system according to claim 1, wherein the payment means is to pay through a network payment.

4. The network leasing system according to claim 1, wherein a valid period of the program data is set based on the day number setting.

5. The network leasing system according to claim 1, wherein the authentication code is calculated through an authentication program and both the translation service receiving end and the translation service providing end have the authentication program.

6. A network leasing method, at least comprising:
setting up a network connection between a translation service receiving end and a translation service providing end;
sending a product serial number to the translation service providing end by the translation service receiving end;
providing at least one function option and a day number setting to the translation service receiving end based on the product serial number by the translation service providing end;
calculating, by the translation service providing end, expenses based on the function options and the day number setting selected by the translation service receiving end and generating a payment means;
providing the payment means for the translation service receiving end to implement a payment transaction by the translation service providing end;
generating an authentication code based on the product serial number by the translation service providing end;
transferring the authentication code and at least one program data corresponding to the selected function options to the translation service receiving end through the network connection by the translation service providing end; and
authenticating, by the translation service receiving end, whether the authentication code is correct or not, wherein if yes, the translation service receiving end installs the program data, otherwise, the translation service receiving end refuses to install the program data.

7. The network leasing method according to claim 6, wherein the translation service receiving end is installed in a personal computer or a notebook.

8. The network leasing method according to claim 6, wherein the payment means is to pay through a network payment.

9. The network leasing method according to claim 6, wherein, the program data set lifespan based on the day number setting.

10. The network leasing method according to claim 6, wherein, the authentication code is derived through computation with an authentication program, and both the translation service receiving end and the translation service providing end have the authentication program.
